(19) United States
(12) Patent Application Publication
(10) Pub. No.: US 2004/0254856 A1
(43) Pub. Date: Dec. 16, 2004

(54) Custom designed floormat order placement system

(76) Inventor: Robert Cameron Dotson, Madison, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/463,767

(22) Filed: Jun. 16, 2003

(51) Int. Cl. G06F 17/60

(52) U.S. Cl. 705/27

(57) ABSTRACT

An automated system for ordering and manufacturing custom designed floormats and chairmats is disclosed. The system may include the steps of entering information related to the desired shape, dimension, and material of the mat and transmitting same, by way of a network connection, such as an Internet connection, from a computer to a server of a mat manufacturer. The entered information can then be transferred from the server to an automated machine tool to manufacture the mat according to the desired specifications and shipped to the customer in a relatively short timeframe.

### FIELD OF THE DISCLOSURE

The disclosure generally relates to floormats and, more particularly, relates to systems for ordering and manufacturing floormats.

### BACKGROUND OF THE DISCLOSURE

Floormats or chairmats are commonly provided in modem offices to provide a stable surface upon which to sit or glide a castered chair. Such mats are typically made from relatively hard plastic having a smooth upper surface, and a textured bottom surface. The textured bottom surface ensures that the mat grips the underlying surface, commonly carpet, to thereby substantially prevent the mat from moving upon the floor. The relatively smooth upper surface facilitates movement of the chair upon the mat.

While such mats are common, custom designing and manufacturing of such mats is relatively cumbersome. For example, in the event of a relatively straightforward shape, such as a rectangular shape, standard sizes can be manufactured and maintained in store inventory to easily satisfy such needs. However, in the event of a uniquely configured work space, it may be desired to manufacture a chairmat having a relatively odd or amorphous shape. In such an event, the ordering and manufacturing of such a mat is relatively difficult. More specifically, the user must first identify the desired shape and area of the floor to be covered by the mat. The user must then measure accurately and provide dimensions for each of the various sides of the mat. Such information is then communicated by telephone or in person to the manufacturer of the mat, who in turn takes the information and manually cuts the mat from a sheet of the desired material.

While such a system does ultimately provide the user with a usable mat of the desired shape and size, it is relatively slow, and given the manual labor component, relatively expensive. It would therefore be useful to provide a system which automates the process for manufacturing a custom designed chairmat.

### SUMMARY OF THE DISCLOSURE

In accordance with one aspect of the disclosure, a method of ordering and manufacturing a chairmat is disclosed which may comprise the steps of accessing an on-line order placement site, identifying a desired shape for the mat, entering dimensions for the desired mat, transferring sheet and dimension data to an automated machine tool, and cutting the desired mat using the automated machine tool.

In accordance with another aspect of the disclosure, a method of ordering a chairmat is disclosed which may comprise the steps of accessing an on-line order placement site, entering a desired shape, entering desired dimensions, entering a desired material, providing customer identification and payment information, and authorizing payment.

In accordance with another aspect of the disclosure, a method of manufacturing a chairmat is disclosed which may comprise the steps of receiving order information from an on-line order placement system, translating the order information into code readable by a CNC machine tool, and manufacturing the chairmat using the CNC machine tool.

These and other aspects and features of the disclosure will be more fully understood given the following detailed description when taken into conjunction with the accompanying drawings.

### BRIEF DESCRIPTION OF THE DRAWINGS

FIG. 1 is a block diagram representation of an order placement and manufacturing system constructed in accordance with the teachings of the disclosure;

FIG. 2 is a flowchart depicting a sequence of steps which may be taken according to the methods disclosed herein;

FIG. 3 is a sample, initial sizing screen according to the teachings of the disclosure;

FIG. 4 is a sample drawing screen according to the teachings of the disclosure;

FIG. 5 is a sample drawing screen after an initial shape has been sketched;

FIG. 6 is a sample drawing screen after a final shape has been reached;

FIG. 7 is a sample mat material selection screen;

FIG. 8 is a sample order confirmation screen; and

FIG. 9 is a sample billing screen according to the teachings of the disclosure.

While the disclosure sets forth various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the invention as defined by the appended claims.

### DETAILED DESCRIPTION OF THE DISCLOSURE

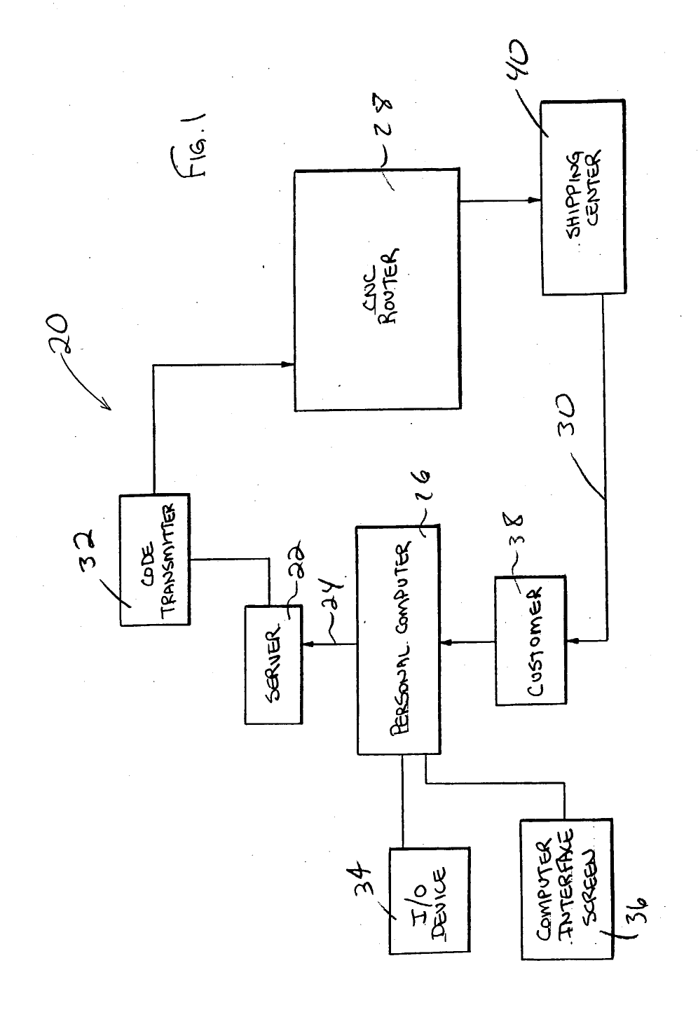

Referring now to the drawings, and with specific reference to FIG. 1, a system for ordering and manufacturing custom designed chairmats is disclosed and generally referred to by reference numeral 20. As shown therein, the system 20 may include a server 22 connected via a network 24 such as an Internet connection to one or more personal computers 26. It is to be understood that each of the personal computers 26 would be provided in remote locations such as a user's home, or business, or in a kiosk fashion within a retail facility or the like. Moreover, it is to be understood that the server 22 would typically be provided in the form of a computer based at a home office or manufacturing facility owned or operated by the manufacturer of such mats. While only one personal computer 26 is depicted, as well as only one server 22, it is to be understood that more than one of each is certainly possible.

Also depicted in FIG. 1, it will be noted that the server is in communication with a machine tool 28 such as a computer numeric control (CNC) router to thereby be enabled to provide instructions to the machine tool for manufacturing the mat. In addition, it will be noted that a code translator 32 is provided to convert the alpha numeric information provided to the server by the personal computer 26 and to code readable by the CNC machine tool 28. The alpha numeric information provided to the server 22 by way of the personal computer 26 may be entered through the input/output device 34 in conjunction with the computer interface screen 36.

In so doing, it will be understood that a customer 38 residing in a location remote from the manufacturer of the mats 30 can enter information into his or her own personal computer 26 through the I/O device 34 and the screen 36 and by way of an Internet connection 24 communicate that information to the server 22 of the manufacturer. The manufacturer in turn can translate the data entered by the user using the code translator 32 into code readable by a machine tool such as the machine tool 28. The machine tool 28, which may be provided in the form of a CNC router, or the like, then proceeds to manufacture the mat 30 in accordance with the desired specifications. Upon completion, the mat is rolled, packaged and shipped to the customer 38 through the shipping center 40 of the manufacturer.

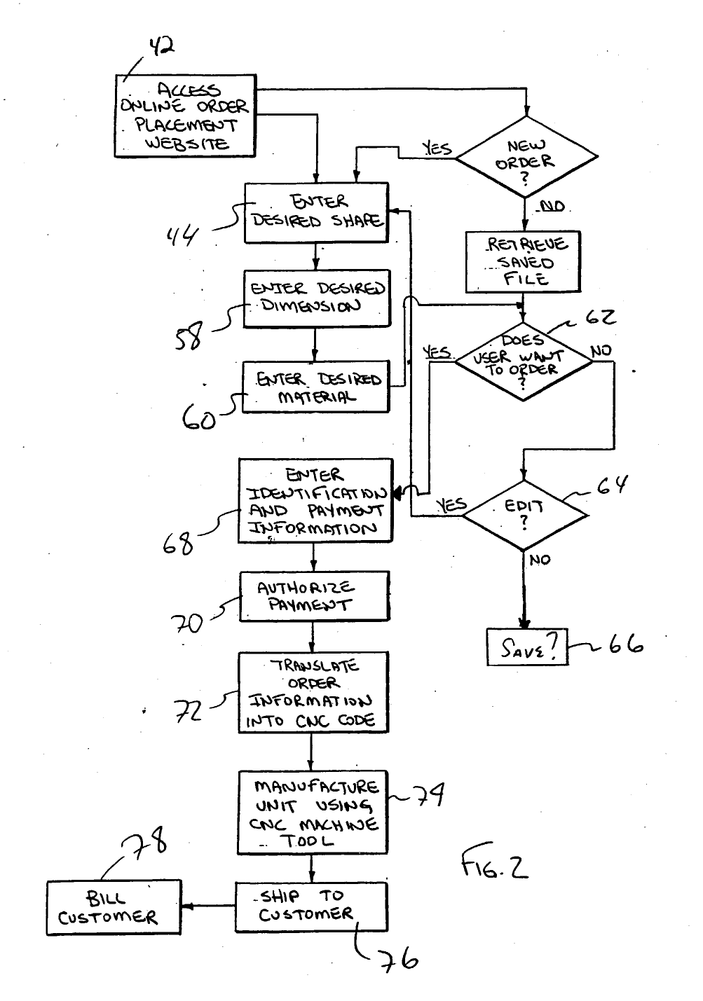

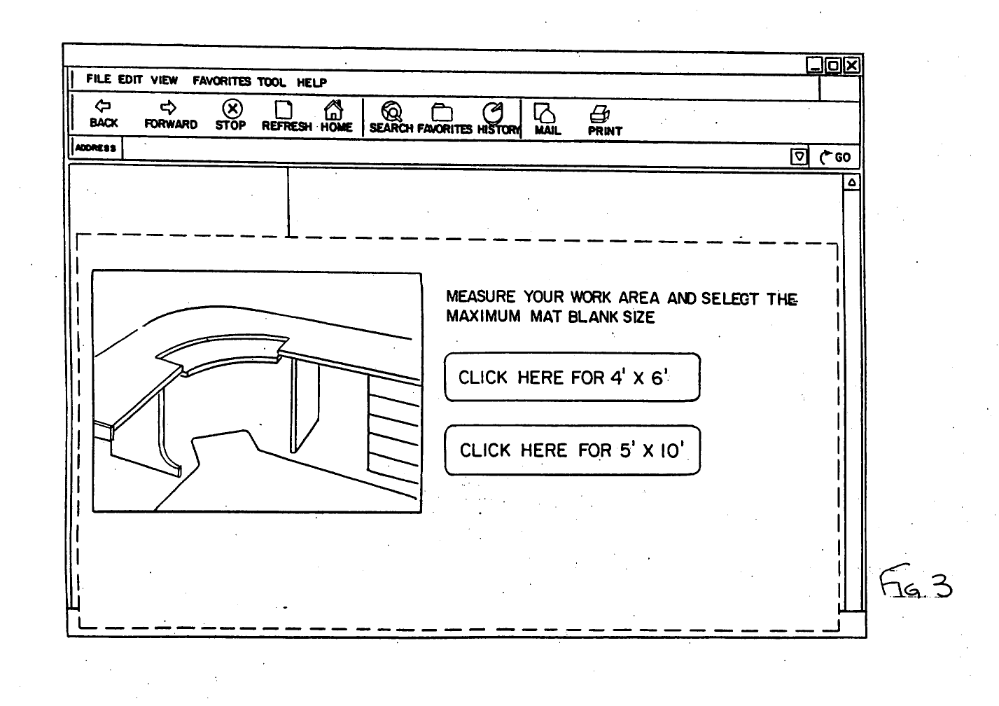

Turning now to FIG. 2, a sample sequence of steps which may be taken in accordance with the teachings of the disclosure is generally set forth in flowchart format. As alluded to with reference to the apparatus of FIG. 1, the system may begin at a step 42 when a user accesses an on-line order placement website of a manufacturer such as through the Internet connection 24. Upon entering the website, a screen such as that depicted in FIG. 3 may appear to the user whereupon he or she is prompted to enter certain information related to the desired mat 30. For example, as indicated in a step 44, the user may begin by selecting the specific size and shape of the mat 30. As shown in FIG. 3, this may be accomplished by first selecting a base sheet stock size such as, a 4′×8′ sheet from which the mat can be cut with minimal waste. If the desired mat has a layer size, another stock sheet such as 5′×10′ or the like, may be selected.

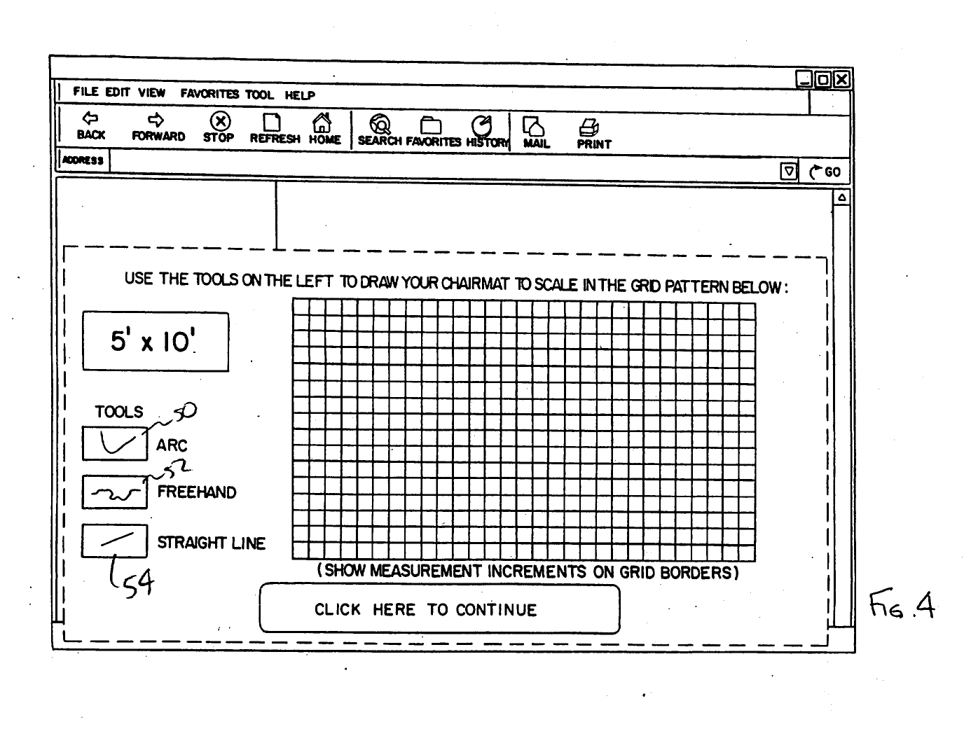

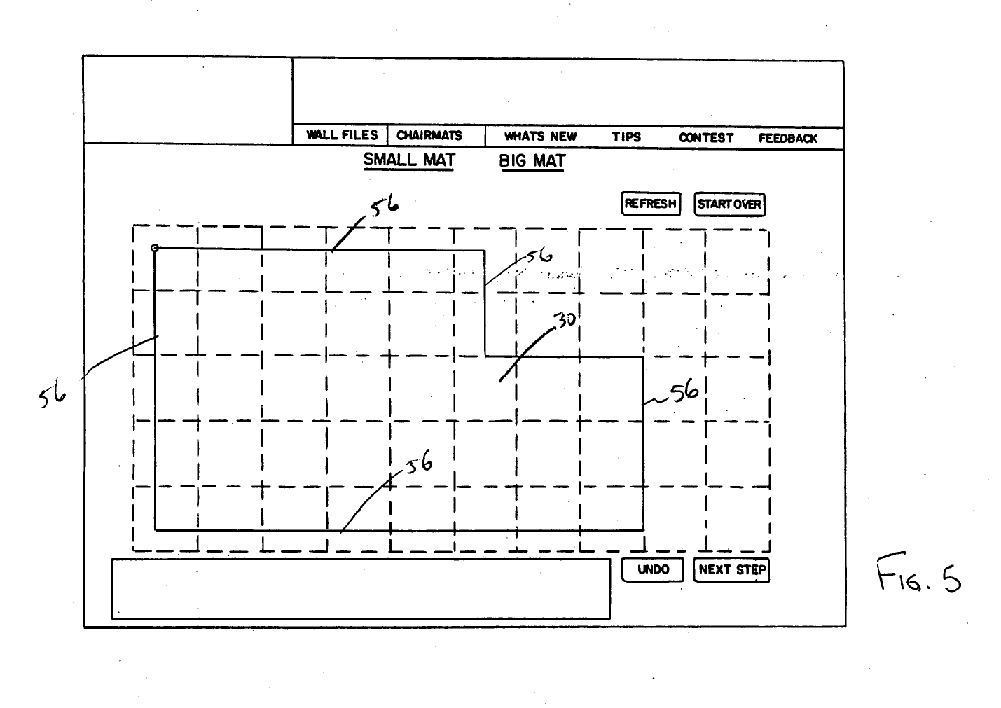

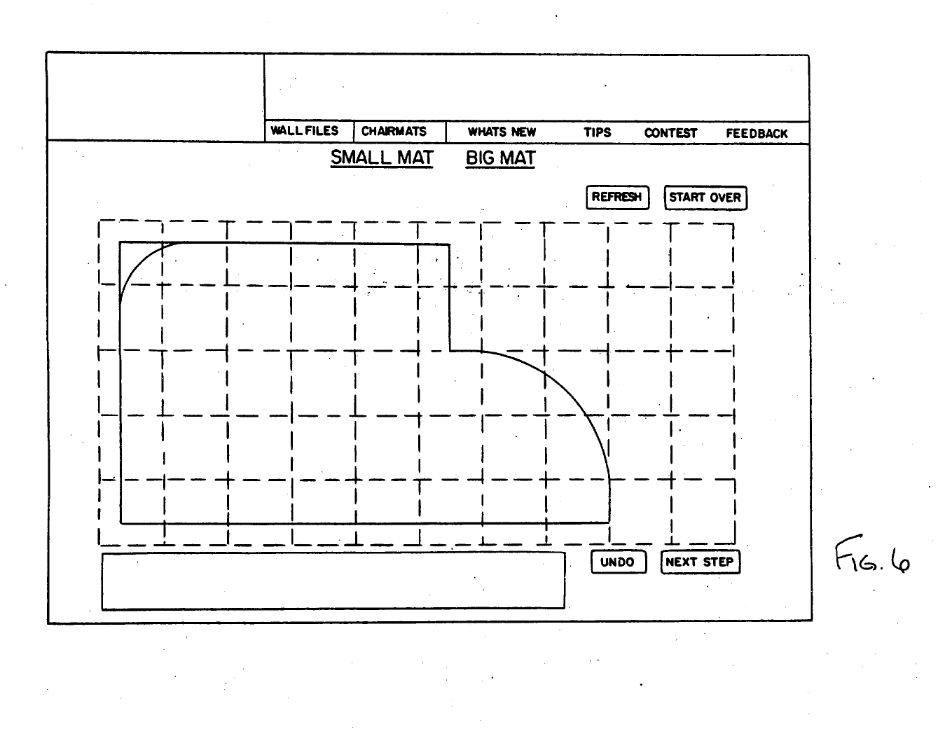

Using a grid 46 superimposed over the selected base shape, the user can then draw the actual desired shape as indicated in FIGS. 5 and 6. Any number of conventional software tools may be employed to draw the mat 30 on the grid 46. For example, as indicated in FIG. 4, a user can select a preprogrammed format for each line 48. As indicated, these may include arcuate lines 50, freehand lines 52, and straight lines 54. One of ordinary skill in the art will readily recognize that by selecting one of the formats, as by clicking on an icon with a mouse-directed on-screen cursor, the user can then click between spots on the grid 46 to create a desired line. Each click will in turn establish a pixel on the grid 46 where the line is to start and/or stop. Moreover, using the arcuate line feature, corners can be rounded as indicated in FIG. 6.

Once the desired overall shape is selected, the user can proceed to enter the dimensions of each of the side walls or side edges 56 of the mat 30 as indicated by step 58. As will be noted from FIG. 6, the desired shape and dimension can be tailored to include not only straight edges, but arcuate and non-conventional shapes as well.

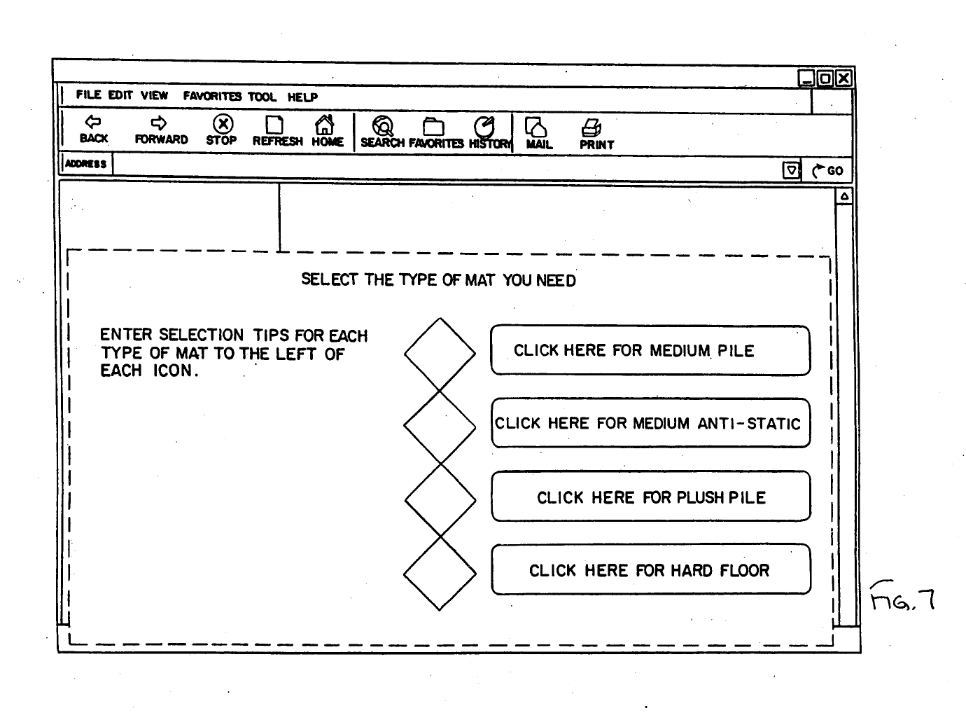

Referring now to FIG. 7, after the desired shape and dimension of the mat 30 are entered, the user is prompted to enter the desired material and/or color of the desired mat as indicated in step 60, the process may further include the steps of selecting a desired texture for both the upper surface and lower surface for the mat 30. For example, the floor surface of the mat 30 may be provided with specific tread or spike patterns to facilitate and enhance the grip of the mat upon the given floor surface.

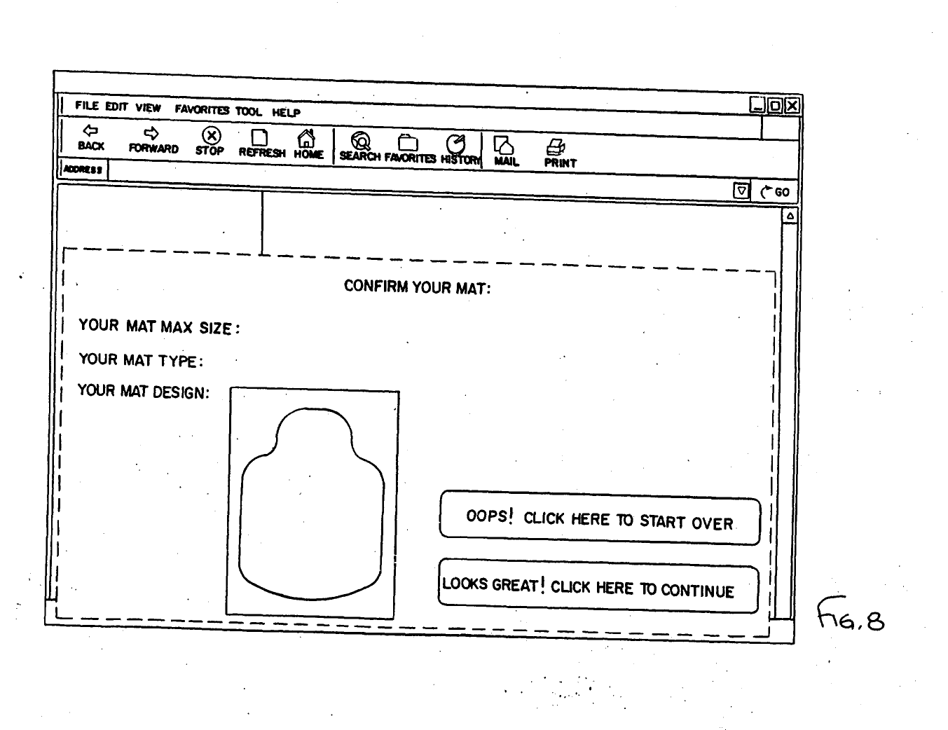

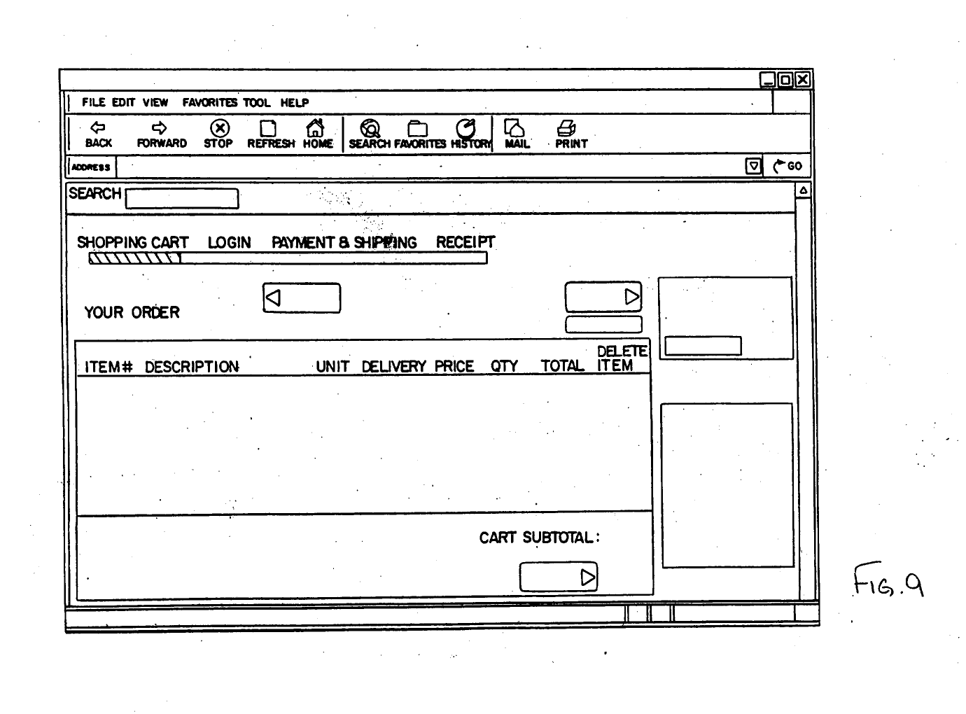

After each of the desired shapes, dimensions, and materials are selected, the user is queried, in a step 62, if he or she wishes to proceed with the order. If the user is not yet ready to place the order, the already entered information can be edited in a step 64 or saved in a step 66 by a memory of the server 22. For example, the user may be provided with a screen as that depicted in FIG. 8, allowing for any of the already entered information to be altered or for the process to start anew. If the user does in fact wish to edit some portion of the order, the program returns to step 44 to enable the information to be re-entered or modified. In the alternative, if the user does in fact wish to proceed with the order at that time, he or she is prompted again to enter information related to his or her identification and payment information as indicated in a step 68. As will be readily understood by one of ordinary skill in the art, this will typically include information as to the name and address of the purchaser, as well as the form of payment and related account number. Once this information is entered, the user is asked if he or she wishes to proceed with the order and if he or she wishes to do so to authorize payment as indicated by a step 70. This typically consists of authorizing payment by way of a credit card number already entered into the system in step 68. FIG. 9 depicts a sample screen which may so used to do so.

Once payment is authorized and the order is placed, the data is translated by the server and put into code readable by the CNC machine tool 28 as indicated by a step 72. This is typically performed by the code translator 32, which may be a separate device, or more commonly provided within the hardware/software of the server 22.

Upon translation, the code is received by the CNC machine tool which automatically proceeds to manufacture the mat 30 according to the desired entered information as indicated by a step 74. This may consist of any number of steps including the automatic retrieval of a sheet stock of material, and cutting of the mat from the sheet stock. The mat sheet stock is typically manufactured from plastic and the mat, can be mechanically cut, sawn, or routed from the sheet stock, or otherwise formed such as through the user of lasers, torches or the like.

Once the mat 30 is completely formed, it can be rolled and packaged at the shipping center 40 as indicated by a step 76. Concurrently with the shipping process, the manufacturer can proceed with the preparation of a bill or invoice for the mat and transmission of same to the customer 38 as indicated by a step 78.

An alternative to entering each of the identified areas of information from scratch is, if the user has already entered information and saved such information as, with step 66, to retrieve the saved data as indicated in a step 80. This may be proceeded by a step 82 of inquires if an order is brand new immediately upon accessing the website.

From the foregoing, one of ordinary skill in the art will readily understand that the teachings of the disclosure can be used for automatic ordering and manufacturing of custom designed floormats and chairmats.

1. A method of ordering and manufacturing a mat, comprising:
accessing an on-line order placement site;
identifying a desired shape for the mat;
entering dimensions for the desired mat;
transferring shape and dimension data to an automated machine tool; and
cutting the desired mat using the automated machine tool.

2. The method of claim 1, wherein the identifying step is performed using a screen grid.

3. The method of claim 1, wherein the automated machine tool is a computer-numeric-controlled machine tool.

4. The method of claim 1, wherein the mat is a chairmat.

5. The method of claim 1, further including the steps of providing customer identification information to the order placement site and shipping the mat to the customer.

6. The method of claim 1, further including the step of selecting the desired mat material and color.

7. The method of claim 1, further including the step of translating the customer entered data into CNC router readable code.

8. A method of ordering a chairmat, comprising:
accessing an on-line order placement site;
entering a desired shape;
entering desired dimensions;
entering a desired material;
providing customer identification and payment information; and
authorizing payment.

9. The method of claim 8, wherein the entering the desired shape step is performed by drawing the desired shape onto a grid provided by the on-line placement site.

10. A method of manufacturing a chairmat, comprising:
receiving order information from an on-line order placement system;
translating the order information into code readable by a CNC machine tool; and
manufacturing the chairmat using the CNC machine tool.

11. The method of claim 10, further including shipping the chairmat to a customer.

12. The method of claim 10, wherein the receiving order information step includes receiving information as to shape, size, color, and material of the desired chairmat.

13. A chairmat order placement system, comprising:
a remote computer;
an Internet connection between the server and the remote computer; and
an automated chairmat cutting machine tool in connection with the base computer.

14. The chairmat order placement system of claim 13, wherein the automated machine tool is a CNC router.

15. The chairmat order placement system of claim 13, further including means for translating data entered by way of the personal computer into code readable by the CNC router.
